(19) United States
(12) Patent Application Publication
(10) Pub. No.: US 2025/0024567 A1
(43) Pub. Date: Jan. 16, 2025

(54) MICROWAVE OVEN APPLIANCE WITH CONTROL FEATURES FOR OPTIMIZING TURNTABLE ROTATION

(71) Applicant: Haier US Appliance Solutions, Inc., Wilmington, DE (US)

(72) Inventor: Craig Nold, Louisville, KY (US)

(21) Appl. No.: 18/353,036

(22) Filed: Jul. 14, 2023

(51) Int. Cl. H05B 6/78

(52) U.S. Cl. CPC H05B 6/782

(57) ABSTRACT

A method for operating a microwave oven appliance may include a step of receiving an input indicative of a cook time of a cook cycle for the microwave oven appliance. The method may also include a step of estimating, based on the received input indicative of the cook time, a number of rotations that a turntable is to complete. The method may further include a step of calculating a rotational time for the turntable based, at least, on the number of rotations estimated. The method may also include a step of activating a motor to rotate the turntable from a home position for the calculated rotational time. The method may further include a step of activating a microwave heating assembly of the microwave oven appliance for the duration of the cook time.

### FIELD

The present subject matter relates generally to microwave oven appliances, and more particularly to systems and methods for operating the microwave oven appliance.

### BACKGROUND

Microwave oven appliances generally include a cabinet that defines a cooking chamber for receipt of food items for cooking. These appliances typically include a rotating turntable that the food items may be placed on. Additionally, these appliances may include one or more heating elements for generating energy to heat the food items during a cooking process, such as a cook cycle. For example, microwave ovens typically include at least one source of electromagnetic radiation in the microwave frequency range, such as a cavity magnetron. In order to provide selective access to the cooking chamber and to contain food particles and cooking energy (e.g., microwaves) during a cooking operation, microwave oven appliances further include a door that is typically pivotally mounted to the cabinet.

In some instances, a user of the microwave oven appliance may place a food item on the turntable within the cooking chamber. The user may select a cooking time for a cook cycle of the microwave oven appliance or a predetermined cooking cycle of the microwave oven appliance. After the completion of the cook cycle, the user may open the door to retrieve the cooked food item. Often, after the completion of the cook cycle, the food items placed on the turntable may not be oriented or placed in a position that is easily accessible to the user of the microwave oven appliance. For example, a user may place a food item at the front of a turntable prior to starting the cook cycle, and after the completion of the cook cycle, the food item may be in the back of the cooking chamber as the turntable did not complete a full rotation. Thus, the user may have to move the heated food item around or manually rotate the turntable to return the food item to a retrievable position. Notably, this may create an unpleasant experience for the user as spills may occur from the manual movement of the food item or the turntable.

Accordingly, a microwave oven appliance that includes systems and methods for optimizing the rotation of the turntable, for example, such that at the completion of the cook cycle, food items may be presented at the same location that they may have been originally placed at, would be useful. More specifically, a method for operating the microwave oven appliance that would automatically determine the quickest approach for the turntable to return to a home position, for example, a position that corresponds to the angular position of the turntable at the commencement of the cook cycle, would be beneficial.

### BRIEF DESCRIPTION

Aspects and advantages of the invention will be set forth in part in the following description, or may be apparent from the description, or may be learned through practice of the invention.

In one exemplary embodiment, a microwave oven appliance is provided. The microwave oven appliance may include a motor mounted within the microwave oven appliance. The microwave oven appliance may also include a turntable attached to the motor. The motor may be operable to rotate the turntable. The microwave oven appliance may further include a microwave heating assembly that may be configured to heat articles within the microwave oven appliance. The microwave oven appliance may also include a controller operably coupled to the microwave oven appliance. The controller may be operable for receiving an input indicative of a cook time of a cook cycle for the microwave oven appliance. The controller may also be operable estimating, based on the received input indicative of the cook time, a number of rotations that a turntable is to complete. The number of rotations may include an estimated number of full rotations and an estimated fractional rotation. The controller may further be operable for calculating a rotational time for the turntable based, at least, on the number of rotations estimated. The rotational time may be independent from the cook time. The controller may also be operable for activating a motor to rotate the turntable from a home position for the calculated rotational time. The turntable may be rotated at a predetermined rotational speed for the calculated rotational time. The controller may further be operable for activating a microwave heating assembly of the microwave oven appliance for the cook time.

In another exemplary embodiment, a method for operating a microwave oven appliance is provided. The method may include a step of receiving an input indicative of a cook time of a cook cycle for the microwave oven appliance. The method may also include a step of estimating, based on the received input indicative of the cook time, a number of rotations that a turntable is to complete. The number of rotations may include an estimated number of full rotations and an estimated fractional rotation. The method may further include a step of calculating a rotational time for the turntable based, at least, on the number of rotations determined. The rotational time may be independent from the cook time. The method may also include a step of activating a motor to rotate the turntable from a home position for the calculated rotational time. The turntable may be rotated at a predetermined rotational speed for the calculated rotational time. The method may further include a step of activating a microwave heating assembly of the microwave oven appliance for the cook time.

In yet another exemplary embodiment, a method for operating a microwave oven appliance is provided. The method may include a step of receiving an input indicative of a sensor cook cycle for the microwave oven appliance. A sensor of the microwave oven appliance may be operable to sense conditions of a food item within the microwave oven appliance during the sensor cook cycle. The method may also include a step of activating a motor to rotate a turntable from a home position at a predetermined rotational speed. The motor may be activated in response to the received input indicative of the sensor cook cycle. The method may further include a step of activating a microwave heating assembly of the microwave oven appliance in response to the received input indicative of the sensor cook cycle. The method may also include a step of sensing, with the sensor, conditions within the microwave oven appliance during the sensor cook cycle. The method may further include a step of determining, based on the sensed conditions, a remaining cook time for the sensor cook cycle. The remaining cook time may commence at the completion of a full rotation of the turntable. The method may also include a step of estimating, based on the determined remaining cook time, a remaining number of rotations that the turntable is to complete. The number of rotations may include a remaining number of full rotations and a remaining fractional rotation. The method may further include a step of calculating a remaining rotational time for the turntable based at least on the number of rotations estimated. The method may also include a step of deactivating the motor to stop rotation of the turntable at the end of the remaining rotational time. The method may further include a step of deactivating the microwave heating assembly at the end of the remaining rotational time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective front view of a microwave oven appliance according to one or more exemplary embodiments of the present subject matter.

FIG. 2 provides a perspective view of the exemplary microwave oven appliance of FIG. 1 with the door in an open position according to one or more exemplary embodiments of the present subject matter.

FIG. 3 provides a schematic illustration of a turntable of the exemplary microwave oven appliance of FIG. 1 according to one or more exemplary embodiments of the present subject matter.

FIG. 4 provides a top down view of the turntable of the exemplary microwave oven appliance of FIG. 1 according to one or more exemplary embodiments of the present subject matter.

FIG. 5 provides a flow diagram of an algorithm that may be used to control a cook cycle of a microwave oven appliance according to one or more exemplary embodiments of the present subject matter.

FIG. 6 provides a flow chart of an exemplary method of operating a microwave oven appliance according to one or more exemplary embodiments of the present subject matter.

FIG. 7 provides a first portion of an additional flow chart of an additional exemplary method of operating a microwave oven appliance according to one or more exemplary embodiments of the present subject matter.

FIG. 8 provides a last portion of the flow chart of FIG. 7.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

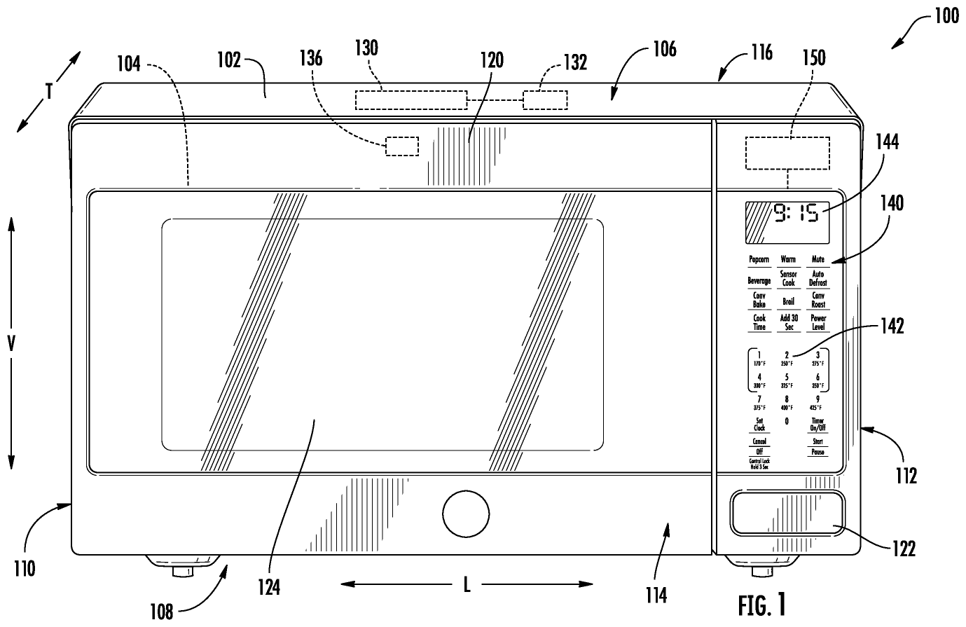

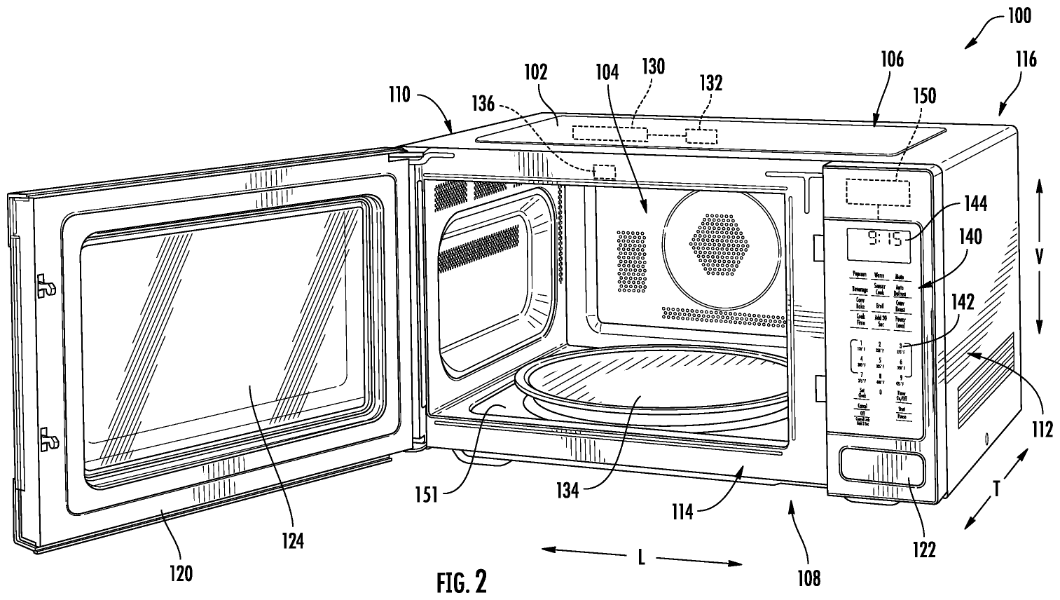

Referring now to the figures, FIG. 1 provides a front view of a microwave oven appliance 100 according to one or more exemplary embodiments of the present subject matter and FIG. 2 provides a perspective view of the microwave oven appliance 100 with the door in an open position. In some embodiments, the microwave oven appliance 100 may include an insulated cabinet 102 that may define a cooking chamber 104 for receipt of food items for cooking. As will be understood by those skilled in the art, the microwave oven appliance 100 may be provided by way of example only, and the present subject matter may be used in any suitable microwave oven appliance, such as a countertop microwave oven appliance, an over-the-range microwave oven appliance, etc. Thus, the exemplary embodiment shown in the figures is not intended to limit the present subject matter in any respect, e.g., the present subject matter is not limited to any particular cooking chamber configuration or arrangement.

As illustrated, the microwave oven appliance 100 may generally define a vertical direction V, a lateral direction L, and a transverse direction T, each of which being mutually perpendicular, such that an orthogonal coordinate system may generally be defined. The cabinet 102 of microwave oven appliance 100 may extend between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

The microwave oven appliance 100 may include a door 120 that may be rotatably attached to cabinet 102 in order to permit selective access to cooking chamber 104. In some embodiments, such as FIGS. 1 and 2, the microwave oven appliance 100 may include a door release button 122 that disengages or otherwise pushes open the door 120 when depressed. Glass windowpanes 124 may be provided for viewing the contents of cooking chamber 104 when door 120 is closed and may also assist with insulating cooking chamber 104.

Alternatively, in some embodiments, that microwave oven appliance 100 may include a handle that may be mounted to door 120, for example, to assist a user with opening and closing door 120 in order to access cooking chamber 104. For example, in such embodiments, a user may pull on the handle to open the door 120 and access cooking chamber 104.

Microwave oven appliance 100 may generally be configured to heat articles, for example, food items such as food or beverages, within cooking chamber 104 using electromagnetic radiation. The microwave oven appliance 100 may include various components which operate to produce the electromagnetic radiation, as is generally understood. For example, the microwave oven appliance 100 may include a microwave heating assembly 130 which may include a magnetron (such as, for example, a cavity magnetron), a high voltage transformer, a high voltage capacitor and a high voltage diode.

According to exemplary embodiments, the microwave oven appliance 100 may further include an inverter power supply 132 that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or inverter power supply 132 may include other suitable components, such as a capacitor that generally connects the magnetron and power supply, such as via high voltage diode, to a chassis. Microwave radiation produced by the magnetron may also be transmitted through a waveguide to cooking chamber 104.

As would be appreciated by one of ordinary skill in the art, the inverter power supply 132 may allow the magnetron's analog electric field intensity to be adjusted between various power levels, such as between ten percent (10%) and one hundred percent (100%) of the total power capacity. By contrast, with conventional non-inverter power supplies, the electric field intensity is either one hundred percent (100%) or zero percent (0%), and power levels are made using a timed duty cycle. For example, a non-inverter power supply set for a fifty percent (50%) power level would turn the magnetron ON at one hundred percent (100%) output power for fifteen seconds, and then OFF for fifteen seconds. At power levels less than one hundred percent (100%), inverter power supply 132 has much better heating uniformity and less penetration depth.

According to alternative embodiments, microwave oven may include one or more heating elements, such as electric resistance heating elements, gas burners, other microwave heating elements, halogen heating elements, or suitable combinations thereof, positioned within cooking chamber 104 for heating cooking chamber 104 and food items positioned therein.

In some embodiments, the microwave oven appliance 100 may include additional features to improve heating uniformity and precision. For example, according to an exemplary embodiment, microwave oven appliance 100 may include a turntable 134 that may be rotatably mounted within cooking chamber 104. The turntable 134 may be selectively rotated during a cooking process to ensure improved temperature uniformity for the object being heated. In addition, microwave oven appliance 100 may include one or more temperature sensors, such as an infrared temperature sensing array 136 that can measure temperatures across the entire bottom of the cooking chamber 104. Temperature sensing array 136 may detect temperatures at various distinct temperature locations, may associate certain locations with the food items being cooked, and may use a subset of the temperature data as feedback for regulating inverter power supply 132, the microwave heating assembly 130, and the cook time for the cook cycle for improved precision.

One of ordinary skill in the art would understand that in alternative embodiments a variety of different sensors may be used, as well as or instead of the temperature sensor(s), to detect various conditions within the cooking chamber and/or of food items within the cooking chamber, for example, during a cook cycle of the microwave oven appliance 100. For example, in some embodiments, the microwave oven appliance 100 may include a moisture sensor that may measure the moisture levels within the cooking chamber 104 during a cook cycle. The moisture data, for example, the moisture levels, may be used as feedback for regulating the inverter power supply 132, the microwave heating assembly 130, and the cook time for the cook cycle for improved precision. Accordingly, it should be appreciated that the temperature sensing array 136 may be provided as a non-limiting example of a sensor that may be included within the microwave oven appliance 100.

In some embodiments, the microwave oven appliance 100 may also include a user interface panel 140 and a user input device 142 that may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical, or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, the microwave oven appliance 100 may include a controller 150 that may be in operative communication with the user input device 142. The user interface panel 140 of the microwave oven appliance 100 may be in communication with the controller 150 via, for example, one or more signal lines or shared communication busses, and signals generated in controller 150 operate microwave oven appliance 100 in response to user input via the user input devices 142. Input/Output (“I/O”) signals may be routed between controller 150 and various operational components of the microwave oven appliance 100. Operation of the microwave oven appliance 100 may be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of the microwave oven appliance 100, and the controller 150 is not restricted necessarily to a single element. The memory may represent random access memory such as DRAM, static random access memory such as SRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

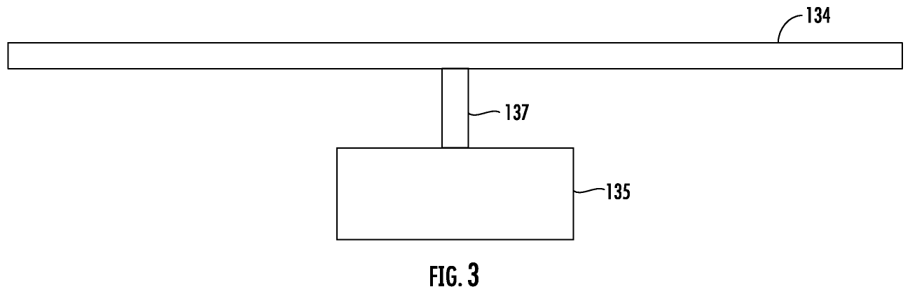

Referring now to FIG. 3, a schematic illustration of the turntable 134 of the exemplary microwave oven appliance 100 according to one or more exemplary embodiments of the present subject matter is provided. In some embodiments, a motor 135 may be provided to drive, or selectively rotate, the turntable 134 during the cooking process, for example, during a cook cycle. The motor 135 may be communicatively coupled to the controller 150 and may be any suitable motor 135 for providing rotational motivating force to the turntable 134. For instance, as illustrated schematically in, a drive shaft 137 may be attached to the motor 135 and the turntable 134 such that rotation provided by the motor 135 may be transferred to the turntable 134.

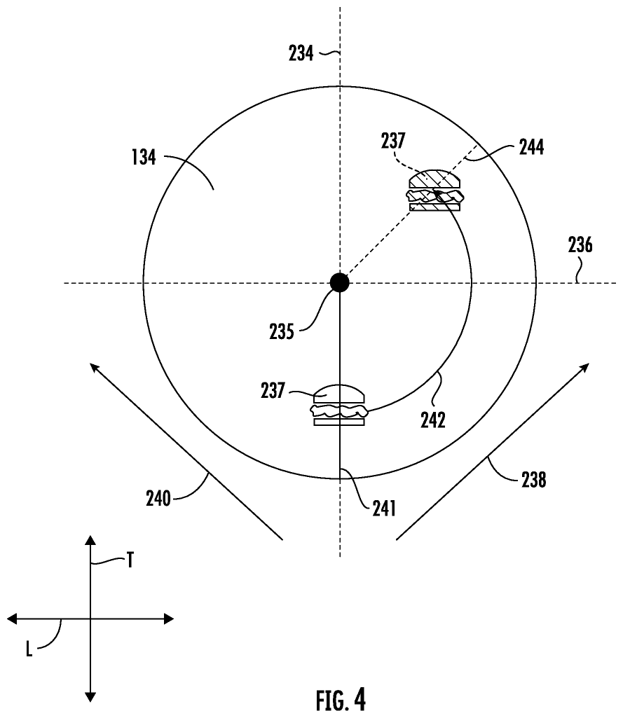

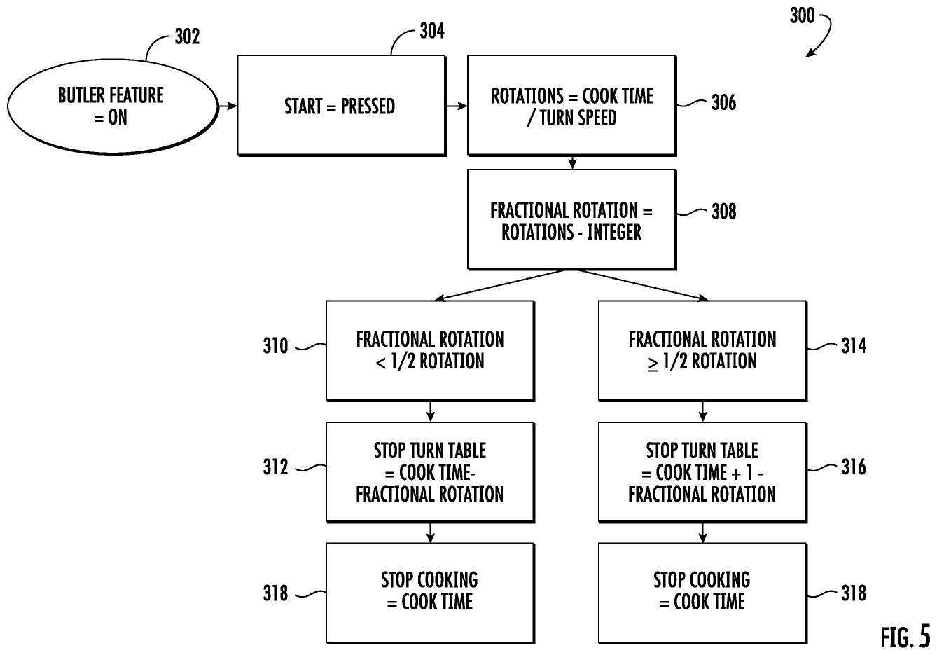

In some embodiments, the motor 135 may be positioned outside of the cooking chamber 104, for example, below a bottom wall 151 (see, for example, FIG. 2) of the cooking chamber 104. In such embodiments, the drive shaft 137 may extend through the bottom wall 151. In some embodiments, the controller 150 may be operable for selectively operating the motor 135 to rotate the turntable 134. As will be described in more detail below, an algorithm 300 (FIG. 5) may be utilized to control the rotation of the turntable 134, for example, such that the rotation of the turntable 134 may be optimized for the presentation of food items that may be placed on the turntable 134. Accordingly, the algorithm 300 may represent a “Butler Mode” or an operation mode that may be configured to determine the quickest way, for instance, at the end of a cook cycle, to reposition a turntable to its original relative angular position. For example, the original relative angular position may be an angular position of the turntable prior to the start of a cook cycle, wherein the angular position is relative to a predetermined position, such as a home position 241 (FIG. 4) described in more detail below.

Referring now to FIG. 4, a top down view of the turntable 134 of the exemplary microwave oven appliance 100 according to one or more exemplary embodiments of the present subject matter is provided. As illustrated in FIG. 4, the turntable 134 may include a first axis 234 that may extend in a first direction, for example, approximately along the transverse direction T, and a second axis 236 that may extend in a second direction that may be approximately perpendicular to the first direction, for example, approximately along the lateral direction L. In some embodiments, the first axis 234 and the second axis 236 may intersect approximately at a midpoint 235 of the turntable, for example, wherein the profile of the turntable 134 is defined by a circular shape, the first axis 234 and the second axis 236 may intersect at a midpoint 235 of the turntable 134, for example, the midpoint 235 may be on a lateral-transverse plane, wherein all radii of the turntable 134, for example, all radii of the circular shape of the turntable 134, may intersect at the midpoint 235.

Moreover, during a cook cycle of the microwave oven appliance 100, the motor 135 (see, for example, FIG. 3) may be capable of rotating the turntable 134 such that the relative angular position of the turntable 134 may change. In some embodiments, the relative angular position of the turntable 134 may be the angular position of the turntable in relation to a home position 241. For example, as illustrated in FIG. 4, the home position 241 may be an angular position that may be approximately in line with the first axis 234 and may be proximate the front of the turntable 134, for example, front of the midpoint 235 approximately along the lateral direction L. For example, as illustrated in FIG. 4, a food item 237 may be positioned approximately at the home position 241 of the turntable 134.

In some embodiments, the exemplary home position 241 may be an “ideal” position for a user of the microwave oven appliance 100 to handle objects that may be on the turntable 134. For instance, the exemplary home position 241 may be proximate the front 114 of the microwave oven appliance 100 such that when a food item may be placed in the home position it may be placed in a comfortable and easily handable position, for example, for a user of the microwave oven appliance 100.

However, it should be appreciated that in some embodiments, the home position 241 may be any suitable predetermined position on the turntable 134, for instance, any suitable angular position of the turntable 134. For example, in some embodiments, the home position 241 may be defined by the position at which a user may place a food item prior to the start of a cook cycle. Thus, in some embodiments, the relative angular position may be an angular position in relation to any suitable predetermined angular position on the turntable 134.

In some embodiments, the motor 135 may selectively rotate the turntable 134 approximately in a first direction 238, such as in a counterclockwise direction, or approximately in a second direction 240 such as in a clockwise direction. Particularly, the rotation of the turntable 134 in the first direction 238, or the second direction 240, may change the relative angular position, for example, with respect to the home position 241, of the turntable 134. The change in the relative angular position may be measured by the angular displacement 242 of the turntable 134. For example, as illustrated in FIG. 4, the change in angular position of the food item 237. for example, from the home position 241 to a reference position 244, may be measured as the angular displacement 242 of the turntable 134 from the home position 241 to the reference position 244. As illustrated, the exemplary change in angular displacement 242 from the home position 241 to the reference position 244 may be approximately one hundred and thirty five degrees.

Referring now to FIG. 5, a flow diagram of an algorithm 300 that may be used to control a cook cycle of a microwave oven appliance, such as the exemplary microwave oven appliance 100, according to one or more exemplary embodiments of the present subject matter. The algorithm 300 described herein, and illustrated in FIG. 5, may be implemented on any suitable microwave oven appliance, for example, to operate the microwave oven appliance. For instance, a controller of the microwave oven appliance, such as the controller 150 of the microwave oven appliance 100, may be operable for implementing the functions of the algorithm 300 such as to operate the microwave oven appliance.

In some embodiments the algorithm may include a start function 302 wherein the Butler Mode may be turned on. The Butler Mode may be turned on when user wishes to have a food item, that may be placed onto the turntable 134, returned to the position it was initially placed at, for example, the home position 241, at the completion of a cook cycle of the microwave oven appliance. The Butler Mode may be configured to position the turntable such that a user may comfortably and easily handle a food item, for example, after the completion of the cook cycle. For example, a user may place a coffee cup, approximately at the home position on the turntable of the microwave oven appliance to cook or warm the contents within the coffee cup. When the Butler Mode is turned on, at the completion of the cook cycle, the coffee cup may be presented to the user at the home position 241.

Moreover, the algorithm 300 may include a process function 304 of starting a cook cycle of the microwave oven appliance. In some embodiments, the process function 304 may include setting a cook time for the cook cycle of the microwave oven appliance 100. In addition, the process function 304 may include pressing a start button of the microwave oven appliance 100 to start the cook cycle for the set cook time.

In some embodiments the algorithm 300 may also include a process function 306 that may be provided to estimate a number of rotations that the turntable may complete during the cook cycle. A full rotation of the turntable may be defined as a three hundred sixty degree rotation of the turntable about its axis of rotation, for example, a full rotation may be defined by the angular displacement of a position on the turntable, such as the home position, equaling three hundred sixty degrees. For instance, the estimated number of rotations may be determined by dividing the set cook time by a predetermined turn speed of the turntable. The predetermined turn speed of the turntable may be a constant speed, for example, angular velocity, at which the turntable may rotate.

Furthermore, in some embodiments the algorithm 300 may include a process function 308 that may be provided to calculate a fractional rotation. In some embodiments, the estimated number of rotations that the turntable may complete during the cook cycle may include a fractional rotation, for example, a change in the relative angular position of the turntable that may be less than three hundred sixty degrees, such as less than a full rotation of the turntable. In such embodiments, the process function 308 may determine the fractional rotation by subtracting a calculation integer from the determined estimated number of rotations. In some embodiments, the calculation integer of process function 308 may be the number of full rotations of the estimated number of rotations. For example, the determined estimated number of rotations may be three and a half rotations for the cook cycle. To determine the fractional rotation, the calculation integer, for example, the whole number of rotations, for instance, three rotations, may be subtracted from the estimated number of rotations, for instance, three and a half rotations. As such the fractional rotation may be a half of a rotation, for example, a relative angular position of one hundred eighty degrees from the home position.

In some embodiments, the algorithm 300 may include a process function 310 that may determine when the fractional rotation may be less than half a rotation, for example, the angular displacement of the fractional rotation may be less than one hundred eighty degrees relative to the home position. In such instances, the algorithm 300 may include a process function 312 that may determine a rotational time for the turntable. The rotational time for the turntable may be a calculated time that represents how long the turntable needs to rotate in order to return the turntable to the home position. For instance, the process function 312 may calculate the rotational time, for example, the time until the rotation of the turntable is stopped, by subtracting, a fractional rotational time, for example, a time that corresponds to the angular displacement of the turntable for the fractional rotation, from the cook time that may have been previously set.

One of ordinary skill in the art would understand that process function 310 described above may be provided by way of example only. In alternative exemplary embodiments, process function 310 may be configured to determine when the fractional rotation is at any suitable predetermined angular displacement relative to the home position. For example, in some embodiments it may be determined at process function 310 that the fractional rotation may be less than three fourths of a rotation. For instance, in such embodiments, the angular displacement of the fractional rotation may be less than two hundred and seventy degrees relative to the home position. As another example, in some embodiments, it may be determined at process function 310 that the fractional rotation may be less than one fourth of a rotation. For instance, in such embodiments, the angular displacement of the fractional rotation may be less than ninety degrees relative to the home position.

Alternatively, in some embodiments, the algorithm 300 may include a process function 314 that may determine when the fractional rotation may be greater than or equal to half a rotation, for example, the angular displacement of the fractional rotation may be greater than or equal to one hundred eighty degrees relative to the home position 241. In such instances, the algorithm 300 may include a process function 316 that may determine a rotational time for the turntable. The rotational time for the turntable may be a calculated time that represents how long the turntable needs to rotate in order to return the turntable to the home position. For instance, the process function 316 may calculate the rotational time, for example, the time until the rotation of the turntable is stopped, by adding, a fractional rotational time, for example, a time that corresponds to the angular displacement of the fractional rotation, to the cook time that may have been previously set.

One of ordinary skill in the art would understand that process function 314 described above may be provided by way of example only. In alternative exemplary embodiments, process function 314 may be configured to determine when the fractional rotation is at any suitable predetermined angular displacement relative to the home position. For example, in some embodiments it may be determined at process function 314 that the fractional rotation may be greater than or equal to three fourths of a rotation. For instance, in such embodiments, the angular displacement of the fractional rotation may be greater than or equal to two hundred and seventy degrees relative to the home position. As another example, in some embodiments, it may be determined at process function 314 that the fractional rotation may be greater than or equal to one fourth of a rotation. For instance, in such embodiments, the angular displacement of the fractional rotation may be greater than or equal to ninety degrees relative to the home position.

The algorithm 300 may also include a process function 318 of stopping cooking, for example, stopping a heating element within the cooking chamber such as the microwave heating element, at the completion of the cook time. The process function 318 may occur after the rotational time is determined such as by the process function 312 or the process function 316. One of ordinary skill in the art would understand the rotational time and the cook time may be independent of one another. That is, the rotational time and the cook time may be separate times that correspond to the turntable and the microwave heating assembly, respectively.

In some instances, the cook cycle of the microwave oven appliance may be unexpectedly interrupted. For example, a user of the microwave oven appliance may open the door of the microwave oven appliance during the cook cycle or pause the cook cycle of the microwave oven appliance. In such instances, when the cook cycle of the microwave oven appliance may be unexpectedly interrupted, the algorithm 300 may be configured to pause the cook time, deactivate the microwave heating element, and return the turntable to the home position in the quickest manner possible.

For instance, based on the angular position of the turntable relative to the home position, when the cook cycle is unexpectedly interrupted the algorithm 300 may be configured to continue rotation of the turntable in the first direction 238, or may reverse the direction of rotation and rotate the turntable in the second direction 240. In this regard, the turntable may be returned back to the home position in the quickest manner possible despite the cook cycle being unexpectedly interrupted.

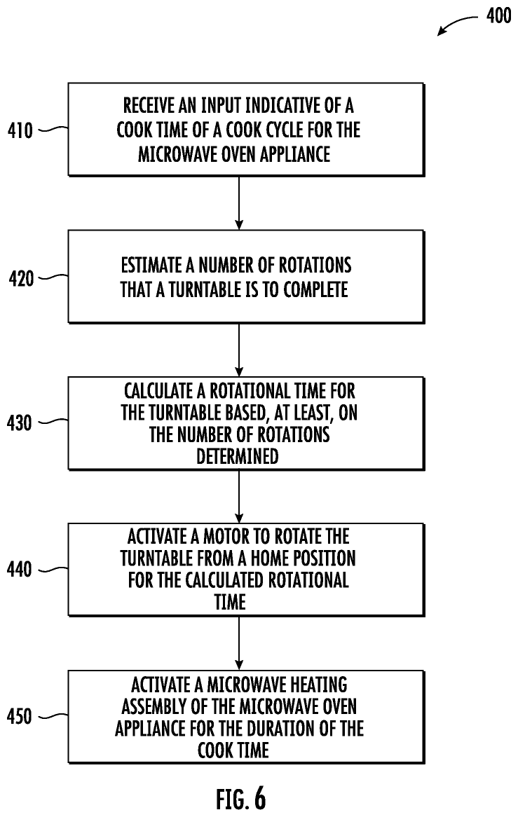

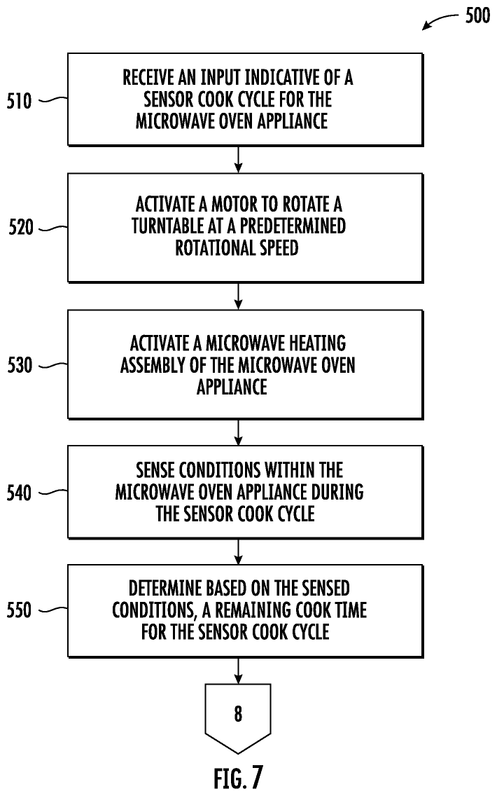

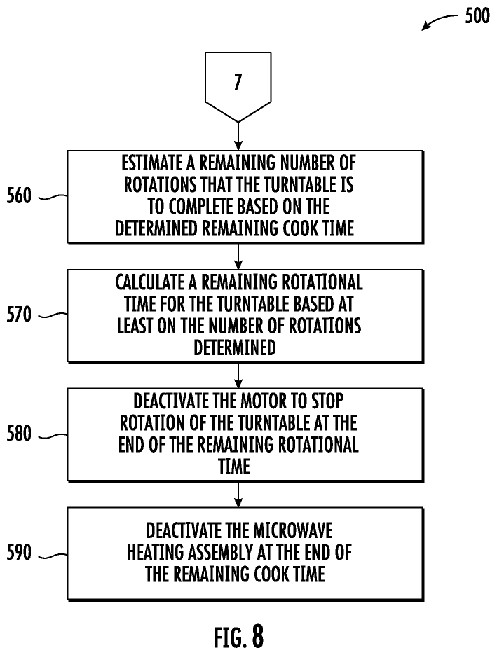

Referring now to FIGS. 6 through 8, embodiments of the present subject matter may include one or more methods for operating a microwave oven appliance, such as the exemplary microwave oven appliance 100 described above, as well as other possible exemplary microwave oven appliances. The exemplary methods according to the present subject matter may include a method 400, for example, as illustrated in FIG. 6, and a method 500, for example as illustrated in FIGS. 7 and 8. A controller of the microwave oven appliance, such as the controller 150 of the exemplary microwave oven appliance 100, may be programmed to implement method 400 and/or method 500, for example, the controller, such as controller 150, may be capable of and may be operable to perform any methods and associated method steps as disclosed herein.

Referring now specifically to FIG. 6, the method 400 may include a step 410 of receiving an input indicative of a cook time of a cook cycle for the microwave oven appliance. In some embodiments, the input received may be an input from a user of the microwave oven appliance. For example, the input indicative of the cook time may be an input by a user of the microwave oven appliance such as a selection of the cook time on a user input device of the microwave oven appliance, for instance, user input device 142 of microwave oven appliance 100. As used herein, the “cook time” of the cook cycle of a microwave oven appliance may be representative of the time a microwave heating assembly, for example, microwave heating assembly 130 of microwave appliance 100, may be activated to heat a cooking chamber and food items therein. Accordingly, the length of activation of the microwave heating element, for example, the length of time that the microwave heating element may be activated to heat a cooking chamber and food items that may be placed therein, may be based on the input indicative of the cook time of the cook cycle.

The method 400 may also include a step 420 of estimating, based on the received input indicative of the cook time, a number of rotations that the turntable may complete. In some embodiments the number of rotations that the turntable may complete may include an estimated number of full rotations and an estimated fractional rotation. The estimated number of full rotations may be an estimate of the number of complete rotations that the turntable may complete during the cook time.

In some embodiments, a full rotation of the turntable may be an approximately three hundred and sixty degree change in the relative angular position of the turntable, for example, the angular displacement of the turntable relative to a predetermined position, such as the home position of the turntable, may be approximately three hundred and sixty degrees. For example, a full rotation of the turntable may reposition a food item that may be placed on the turntable back at its original position, for example, the position the food item was originally placed at on the turntable. For instance, a food item that may be placed approximately at the home position on the turntable, for example, prior to the start of a cook cycle, may be repositioned approximately at the home position after the full rotation of the turntable.

Moreover, the fractional rotation of the turntable may be a less than approximately three hundred and sixty degree change in the relative angular position of the turntable, for example, the angular displacement of the turntable relative to a predetermined position, such as the home position of the turntable, may be less than approximately three hundred and sixty degrees. For example, a fractional rotation of the turntable may reposition a food item that may be placed on the turntable at a position that may be different from its original position, for example, the position the food item was originally placed at on the turntable. For instance, a food item that may be placed approximately at the home position on the turntable, for example, prior to the start of a cook cycle, may be repositioned at a different position, for example, an angular position that is not the same as the home position, after the fractional rotation of the turntable.

In some embodiments, the fractional rotation may be based on the estimated number of rotations and a calculation integer. The calculation integer may correspond to the estimated number of full rotations. For example, in some embodiments, the calculation integer may be the estimated number of full rotations. Moreover, the fractional rotation may be the difference between the estimated number of rotations and the calculation integer, for example, the estimated number of full rotations.

For example, the number of rotations may be estimated to be three and a half rotations. In such a case the fractional rotation may be the difference between the estimated number of rotations, for example, the three and half rotations, and the estimated number of full rotations, for example, three full rotations. Accordingly, in the exemplary case the fractional rotation may be calculated to be half a rotation, for example, an angular displacement of the turntable that is approximately one hundred and eighty degrees.

The method 400 may further include a step 430 of calculating a rotational time for the turntable based, at least, on the number of rotations estimated, wherein the rotational time may be independent from the cook time, for example, the rotational time and the cook time may represent the activation time for different components of the microwave oven appliance, such as the turntable and the microwave heating element, respectively. Moreover, in some embodiments, the step 430 may be based on the estimated fractional rotation and a fractional time that may correspond to the fractional rotation. For example, in some instances, such as when the fractional rotation is estimated to be less than half of a full rotation, the step 430 of calculating the rotational time for the turntable may further be based, at least, on the cook time and the fractional time, wherein the fractional time may be a time that represents the estimated fractional rotation, for example, a time that it takes the estimated fractional rotation to complete its corresponding angular displacement.

As another example, such as when the estimated fractional rotation may be greater than or equal to half of a full rotation, for example, when the estimated fractional rotation includes a change in the relative angular position that may be greater than or equal to one hundred and eighty degrees, the step 430 of calculating the rotational time for the turntable may further be based, at least, on the cook time, a calculation integer, and the fractional time, wherein the calculation integer may be the time it takes the turntable to complete one full rotation, and wherein the fractional time may be a time that represents the time it takes the estimated fractional rotation to complete its corresponding angular displacement.

The method 400 may also include a step 440 of activating a motor, such as the motor 135 of microwave oven appliance 100, to rotate the turntable, from a home position, for example a position wherein the change in the relative angular position of the turntable may be approximately zero, for the calculated rotational time, wherein the turntable is rotated at a predetermined rotational speed for calculated rotational time. Particularly, the step 440 may be provided to start, or commence, the rotation of the turntable, such that food items that may be positioned within the microwave oven appliance on the turntable may cook evenly, or more uniformly, during the cook cycle. Furthermore, at the completion of the calculated rotational time, the turntable may be repositioned at the home position as the rotational time may be independent from the cook time. For instance, the rotational time may run longer, or shorter, than the cook time such that the turntable may be repositioned at the home position at the end of the cook cycle.

The method 400 may further include a step 450 of activating a microwave heating assembly of the microwave oven appliance for the cook time. The step 450 may be provided to heat the cooking chamber and food items that may be placed therein during the cook cycle. Moreover, in some embodiments, the method 400 may further include a step of determining that the rotational time is longer than the cook time. Where the rotational time is longer than the cook time, the method 400 may also include a step of activating, in response to the determined rotational time being longer than the cook time, a cooling fan when the cook time has elapsed and deactivating the cooling fan when the rotational time has elapsed. Thus, when the rotational time is longer than the cook time, for example, when the fractional rotation is greater than or equal to half a rotation, the impression of the difference between the rotational time and to cook time, for example, the impression of the difference to a user of the microwave oven appliance may be masked, for example, made not apparent, from the user of the microwave oven appliance.

Referring now to FIG. 7, a first portion of the method 500 according to one or more exemplary embodiments of the present subject matter is provided. The method may include a step 510 of receiving an input indicative of a sensor cook cycle for the microwave oven appliance, wherein a sensor of the microwave oven appliance, for example, the temperature sensing array 136 of the microwave oven appliance 100. may be operable to sense conditions within the cooking chamber of the microwave oven appliance during the sensor cook cycle. For example, in some embodiments, the sensor may be operable to sense conditions of food items that may be placed within the cooking chamber. Moreover, the sensor cook cycle may be operable for cooking or heating the cooking chamber and food items that may be placed therein without the selection of a specific cook time, power level, or combination thereof. Specifically, the sensor cook cycle may automatically determine the required cook time for a food item that may be placed within the microwave oven appliance.

The method 500 may also include a step 520 of activating a motor to rotate a turntable, for instance, from a home position. In some embodiments, the home position may be a position wherein the relative angular position of the turntable may be approximately zero. Furthermore, in some embodiments, the motor may be activated to rotate the turntable at a predetermined rotational speed. For instance, the predetermined rotational speed may be a constant speed, for example, a constant angular velocity of the turntable rotation. In addition, in some embodiments, the motor may be activated in response to the received input indicative of the sensor cook cycle. The method 500 may further include a step 530 of activating a microwave heating assembly of the microwave oven appliance in response to the received input indicative of the sensor cook cycle.

The method 500 may also include a step 540 of sensing, with the sensor, conditions within the microwave oven appliance during the sensor cook cycle. For example, during the sensor cook cycle, the sensor, for example, the temperature sensing array 136, may sense conditions, for example, temperature and moisture levels, within the cooking chamber. As the turntable is rotating and the microwave heating element is heating the cooking chamber, often the conditions within the microwave oven appliance may change. Thus, the sensor may sense and may collect data indicative of these conditions and may use this data as feedback to regulate the sensor cook cycle, for example, to automatically determine the cook time for the sensor cook cycle.

In some embodiments, the sensor cook cycle may run and may continue to sense the conditions within the cooking chamber and collect data indicative of these conditions until it may be determined that the sensor cook cycle is nearing its completion. For example, it may be determined that the food items within the cooking chamber or almost cooked or heated to the desired doneness. Thus, in some embodiments, the remaining cook time for the sensor cook time may be determined when the sensor cook cycle senses that the sensor cook cycle is nearing its completion. Accordingly, the method 500 may further include a step 550 of determining based on the sensed conditions, a remaining cook time for the sensor cook cycle, wherein the remaining cook time commences after a full rotation of the turntable.

Referring now to FIG. 8, a last portion of the method 500 is provided. As illustrated in FIG. 8, the method 500 may also include a step 560 of estimating, based on the determined remaining cook time, a remaining number of rotations that the turntable may complete. In some embodiments, the remaining number of rotations that the turntable may complete may include a remaining number of full rotations and a remaining fractional rotation. The remaining number of full rotations may be an estimate of the number of complete rotations that the turntable may complete during the remaining cook time. A full rotation of the turntable may be represented by a change in the relative angular position of the turntable, for example, the angular displacement of the turntable from a predetermined position, such as the home position, that may be approximately three hundred and sixty degrees. The remaining fractional rotation of the turntable may be, for example, a less than complete revolution of the turntable, such as when the change in relative angular position of the turntable, for example, the angular displacement, is approximately less than three hundred and sixty degrees.

In some embodiments, the remaining fractional rotation may be based on the remaining number of rotations and a calculation integer. The calculation integer may correspond to the remaining number of full rotations. For example, in some embodiments, the calculation integer may be the remaining number of full rotations. Moreover, the remaining fractional rotation may be the difference between the estimated number of rotations and the calculation integer, for example, the remaining number of full rotations.

The method 500 may further include a step 570 of calculating a remaining rotational time for the turntable based at least on the remaining number of rotations estimated, wherein the remaining rotational time may be independent from the remaining cook time, for example, the remaining rotational time and the remaining cook time may represent the remaining activation time for different components of the microwave oven appliance, such as the turntable and the microwave heating element, respectively. In some instances, such as wherein the remaining fractional rotation is less than half of a full rotation, the step 570 of calculating the remaining rotational time for the turntable is further based, at least, on the remaining cook time and a remaining fractional time that may correspond to the remaining fractional rotation. In other instances, such as wherein the remaining fractional rotation may be greater than or equal to half a rotation calculating the remaining rotational time for the turntable may further be based, at least, on the cook time, a calculation integer, and a remaining fractional time that corresponds to the remaining fractional rotation.

The method 500 may also include a step 580 of deactivating the motor to stop rotation of the turntable at the end of the remaining rotational time. In some embodiments, at the end of the calculated remaining rotational time, the turntable may be repositioned at the home position. The method 500 may further include a step 590 of deactivating the microwave heating assembly at the end of the remaining cook time.

Referring now generally to FIGS. 6 and 7, the methods 400 and 500 may be interrelated and/or may have one or more steps from one of the methods 400 and 500 combined with other method 400 and 500. Thus, those of ordinary skill in the art will recognize that the various steps of the exemplary methods described herein may be combined in various ways to arrive at additional embodiments within the scope of the present disclosure. For example, the method 400 may also include one or more of the exemplary steps described above with respect to the method 500 or vice versa.

Exemplary embodiments of the present subject matter described herein may advantageously improve a microwave oven appliance and a user experience by optimizing the rotation of a turntable of the microwave oven appliance. Particularly, the exemplary subject matter may advantageously improve operation of the microwave appliance by utilizing the algorithm 300 and methods 400 and 500 to determine the quickest approach to a home position of the turntable.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave oven appliance comprising:
a motor mounted within the microwave oven appliance;
a turntable attached to the motor, whereby the motor is operable to rotate the turntable;
a microwave heating assembly configured to heat articles within the microwave oven appliance; and
a controller, the controller operable for:
receiving an input indicative of a cook time of a cook cycle for the microwave oven appliance;
estimating, based on the received input indicative of the cook time, a number of rotations that the turntable is to complete, the number of rotations comprising an estimated number of full rotations and an estimated fractional rotation;
calculating a rotational time for the turntable based on the number of rotations estimated, wherein the rotational time is independent from the cook time;
activating the motor to rotate the turntable from a home position for the calculated rotational time, wherein the turntable is rotated at a predetermined rotational speed for the calculated rotational time; and
activating the microwave heating assembly of the microwave oven appliance for the cook time.

2. The microwave oven appliance of claim 1, wherein the fractional rotation is based on the number of full rotations and a calculation integer.

3. The microwave oven appliance of claim 1, wherein the fractional rotation is less than half of a full rotation, and wherein calculating the rotational time for the turntable is further based on the cook time and a fractional time that corresponds to the fractional rotation.

4. The microwave oven appliance of claim 1, wherein the fractional rotation is greater than or equal to half a rotation, and wherein calculating the rotational time for the turntable is further based on the cook time, a calculation integer, and a fractional time that corresponds to the fractional rotation.

5. The microwave oven appliance of claim 1, wherein a relative angular position of the turntable is approximately zero in the home position.

6. The microwave oven appliance of claim 5, wherein at the completion of the calculated rotational time, the turntable is repositioned at the home position.

7. The microwave oven appliance of claim 1, wherein the rotational time is longer than the cook time, further comprising activating a cooling fan when the cook time has elapsed and deactivating the cooling fan when the rotational time has elapsed.

8. A method for operating a microwave oven appliance, the method comprising:
receiving an input indicative of a cook time of a cook cycle for the microwave oven appliance;
estimating, based on the received input indicative of the cook time, a number of rotations that a turntable is to complete, the number of rotations comprising an estimated number of full rotations and an estimated fractional rotation;
calculating a rotational time for the turntable based on the number of rotations estimated, wherein the rotational time is independent from the cook time;
activating a motor to rotate the turntable from a home position for the calculated rotational time, wherein the turntable is rotated at a predetermined rotational speed for the calculated rotational time; and
activating a microwave heating assembly of the microwave oven appliance for the cook time.

9. The method of claim 8, wherein the fractional rotation is based on the number of full rotations and a calculation integer.

10. The method of claim 8, wherein the fractional rotation is estimated to be less than half of a full rotation, and wherein calculating the rotational time for the turntable is further based on the cook time and a fractional time that corresponds to the fractional rotation.

11. The method of claim 8, wherein the fractional rotation is estimated to be greater than or equal to half a rotation, and wherein calculating the rotational time for the turntable is further based on the cook time, a calculation integer, and a fractional time that corresponds to the fractional rotation.

12. The method of claim 8, wherein a relative angular position of the turntable is approximately zero in the home position.

13. The method of claim 12, wherein at the completion of the calculated rotational time, the turntable is repositioned at the home position.

14. The method of claim 8, further comprising determining the rotational time is longer than the cook time and activating, in response to the determined rotational time being longer than the cook time, a cooling fan when the cook time has elapsed and deactivating the cooling fan when the rotational time has elapsed.

15. A method for operating a microwave oven appliance, the method comprising:
receiving an input indicative of a sensor cook cycle for the microwave oven appliance, wherein a sensor of the microwave oven appliance is operable to sense conditions within a cooking chamber of the microwave oven appliance during the sensor cook cycle;
activating a motor to rotate a turntable from a home position at a predetermined rotational speed, wherein the motor is activated in response to the received input indicative of the sensor cook cycle;
activating a microwave heating assembly of the microwave oven appliance in response to the received input indicative of the sensor cook cycle;
sensing, with the sensor, conditions within the microwave oven appliance during the sensor cook cycle;
determining, based on the sensed conditions, a remaining cook time for the sensor cook cycle, wherein the remaining cook time commences after a full rotation of the turntable;
estimating, based on the determined remaining cook time, a remaining number of rotations that the turntable is to complete, the number of rotations comprising a remaining number of full rotations and a remaining fractional rotation;
calculating a remaining rotational time for the turntable based at least on the number of rotations estimated;
deactivating the motor to stop rotation of the turntable at an end of the remaining rotational time; and
deactivating the microwave heating assembly at the end of the remaining cook time.

16. The method of claim 15, wherein the remaining fractional rotation is based on the remaining number of full rotations and a calculation integer.

17. The method of claim 15, wherein the remaining fractional rotation is less than half of a full rotation, and wherein calculating the remaining rotational time for the turntable is further based on the cook time and a remaining fractional time that corresponds to the remaining fractional rotation.

18. The method of claim 15, wherein the remaining fractional rotation is greater than or equal to half a rotation, and wherein calculating the remaining rotational time for the turntable is further based on the cook time, a calculation integer, and a remaining fractional time that corresponds to the remaining fractional rotation.

19. The method of claim 15, wherein angular displacement of the turntable in the home position is approximately zero degrees.

20. The method of claim 19, wherein at the end of the calculated remaining rotational time, the turntable is repositioned at the home position.
